(19) United States
(12) Patent Application Publication
(10) Pub. No.: US 2025/0198106 A1
(43) Pub. Date: Jun. 19, 2025

(54) PURE WATER AUTOMATION SYSTEM

(71) Applicant: George Andrew Lear, III, Lake Tapps, WA (US)

(72) Inventor: George Andrew Lear, III, Lake Tapps, WA (US)

(21) Appl. No.: 18/895,215

(22) Filed: Sep. 24, 2024

Related U.S. Application Data
(60) Provisional application No. 63/540,352, filed on Sep. 25, 2023.

(51) Int. Cl. E02B 15/10

(52) U.S. Cl. CPC E02B 15/10

(57) ABSTRACT

A sonar equipped, teleoperated robotic lake or aquatic cleaning apparatus that removes debris and biomass such as aquatic invasive species (AIS) from bodies of water by way of a remotely operated vehicle (ROV) and autonomous dump barges. The remotely operated vehicle manipulates the proprietary tool/system to extract weed, root masses and fragments at prolific rates. The use of artificial intelligence and machine learning allows for an autonomous operation and maximizes the amount of waste that is removed from aquatic environments relative to other approaches and democratizes data regarding the production and removal of aquatic invasive species (AIS) and the conditions of bodies of water.

### CROSS REFERENCE TO RELATED APPLICATIONS

This application claims the benefit of U.S. Provisional Patent Application Ser. No. 63/540,352, filed Sep. 25, 2023, the contents of which are incorporated herein by reference.

### BACKGROUND OF THE INVENTION

Aquatic Invasive Plant Species (AIS) are destroying freshwater ecosystems and are worsening due to climate change. AIS causes hundreds of billions of dollars in damage annually, which makes large-scale, sustainable solutions to control the spread and growth of AIS a desperate need. Current attempts to control AIS are superficial, are localized in their approach and do not attempt to address the problem at scale. The most effective approaches are the most expensive and require a lot of human labor, time, and capital. Other approaches, such as cutting the invasives only remedies the issue temporarily, as there are still root systems, fragments and biomass in the water which further complicate the process long term. Chemical treatments and applications, while initially appealing for their low cost, are a short-term solution which, over time, create chemical resistant strains, force plant hybridization (creating a more robust species) and can have secondary and tertiary impacts to the environment. This is a temporary, short-term solution that exacerbates the problem due to disruptions in the nutrient balance in the water column as well as negative impacts to native plants and wildlife. All current approaches are insufficient in reducing the rate of infestation or slowing the plant's ability to reproduce to a level where ongoing treatment can be cost-effectively managed.

The most prolific of all aquatic invasive species (which is growing in the Midwest at a compound annual growth rate of 15 to 20 percent) is myriophyllum spicatum, or Eurasion Water Milfoil, or simply Milfoil, which empirical research has shown impairs property values by 15 to 20 percent; the size and scope of milfoil infestation can grow severe enough to involve the Department of Environmental Protections who often declare when an ecosystem has been contaminated, diminishing the property's value, and making it less saleable. Milfoil also decreases the value of recreational activities such as fishing, swimming, and other water sports. This species decreases the profitability of agricultural production, while increasing the cost of electricity generation and the provision of municipal water supplies. States like Michigan, Minnesota, and Wisconsin are experiencing severe Eurasian Watermilfoil (also known as spiked water-milfoil) infestations. Recent research has shown that invasive plant species also negatively impact the nutrient balance within freshwater systems, reducing the availability of dissolved oxygen and dissolved phosphorous at the lower levels of a lake. While invasive aquatic plants themselves can sequester carbon, the oxygen deficiency created by the plants leads to anaerobic decomposition. Anaerobic decomposition produces methane, a gas that has more than eighty times the warming power of CO2 in the atmosphere. Removing these aquatic invasive plants becomes even more imperative.

With lake and river systems greatly entwined, preserving these bodies of water, and keeping them clean and fresh is essential for those who rely on these systems. As the climate continues to warm, the freshwater system will come under increasing strain, and preservation of freshwater ecosystems will become increasingly more paramount.

The present invention prescribes a semi-autonomous aquatic vehicle for the collection of aquatic invasive species and weeds. It is environmentally sustainable, cost effective while also creating multiple modes of monetization for the impacted industries. The vehicle itself contains an underwater suction system that draws the weeds into a proprietary funnel via a custom designed, focused stream of water, removes them from the ecosystem and then collects them topside in containment system at a higher rate of progress when compared to methods using human labor power such as divers. This can also be done and at a lower operating cost. This vehicle is remotely operated, which means the previous approach of exhausting human labor power is no longer necessary. The invention also generates immensely valuable data because of its AI and machine learning components that will lead to operating efficiencies as well as the collection of local, regional, state and national data on the health of freshwater.

With over 10,000 lakes infested with invasive species such as Eurasian Water-Milfoil in the upper Midwest alone (Minnesota, Wisconsin, Michigan, Indiana, Ohio, Pennsylvania) and with the invasion growing at over 15% CAGR, a complete infestation is estimated by 2035. Climate change will dictate the terms of the future water economy, so it is imperative that the present invention be utilized and expanded to create and shape the industry by creating a cost effective, scalable, environmentally optimal, prolific solution to invasive species removal.

### SUMMARY OF THE INVENTION

The present invention is a teleoperated robotic water cleaning apparatus, such as an autonomous underwater vehicle, that targets aquatic invasive species (AIS). It utilizes sensing technology and artificial intelligence and machine learning. Its primary operation improves freshwater environments and is equipped with the appropriate functions to initially extract Eurasian watermilfoil (myrophylum spicatum) the “gateway” species to begin the journey of extraction, but it is also engineered to target other aquatic invasive species from bodies of water. The previous iteration involving a diver is now exchanged for a remotely operated vehicle (ROV) which manipulates the proprietary tool to extract weed, root masses and fragments. The use of artificial intelligence allows for an autonomous operation and maximizes the amount of targeted biomass, which may include both plant and/or animal organisms, to be removed from aquatic environments relative to other approaches, for example, diver assisted suction harvesting (DASH), mechanical cutting (harvesting), chemicals, or other competitive species like grass carp or weevils. Significant to note is that while the present invention may be utilized in a lake environment or ecosystem, its features and capabilities extend beyond particular bodies of water, and may be applied to a variety of ecosystems, such as organic bodies of water such as streams, rivers, seas or oceans, or non-organic bodies of water that it may be configured within.

The vehicle may also be in a tethered or untethered form. That is, it may require an umbilical or cord that connects to another apparatus, and work autonomously without excess cording and transfer waste by other means, for example, via containment and removal. There are two connections from the surface/command boat to the present invention; one hose to remove biomass, and one umbilical/tether. These appendages may also be integrated into one connective system or kept separate so that the hose removes unwanted biomass and the umbilical and tether provide powers, communication, and data retrieval operations using a live camera feed and other sensors or detection methods.

The present invention removes debris and streamlines the process without the need of excessive human labor as it is remotely operated. The vehicle itself will provide buoyancy and a propulsion unit that avoids debris such as AIS from interfering with the activities of the thrusters/control mechanisms. It maintains sonar and infrared/optical capabilities that allow, if necessary, a depiction of its waste collection and pathways to remote monitoring facilities.

Executed with the use of infrared technology, by way of example and not by way of limitation, the apparatus may feature thermal imaging cameras, night surveillance, and tracking. Sonar technology, also known as sound navigation and ranging, is also imperative to the present invention. Sound propagation assists greatly in an aquatic environment and is used to help efficiently navigate distance and detect objects that may be on or under the water, as well as provide information on orientation, heading and positioning of the system. This quality also ensures that the water cleaning vehicle does not come into contact or obtrude with any foreign objects, and when paired with the faculty of artificial intelligence, it can learn not to allow these events to reoccur. All components are robust, infixed within durable, rugged pieces of equipment in order to avoid or minimize the amount of damage that may occur as a result of inadvertent contact with obstacles or the lake or river bottom.

In one embodiment of the present invention, it operates in collaboration with a pontoon boat or ‘mother vessel’ which houses the appropriate controls where one can acquire data about how well the cleaning vehicle has been utilized, its rate of progress, its efficiency, its precise location in depth, heading and GPS orientation. This also creates an ecosystem wherein the apparatus can communicate, for example, using radio frequency communications to establish a communication link, with the remote operating systems and consequently any personnel who oversees deploying, monitoring, or running diagnostics on the lake or aquatic cleaning apparatus. Data collection can be sent to an external server, or a cloud-based server operating over a network and stored in working memory that is housed within a waterproof panel of the present invention and provide real-time updates to a database, which allows researchers and interested parties to review the development of the extraction process. Data collected may even be used to create a point cloud, specifically for LiDAR (light detection and ranging) scanning or photogrammetry. These data points may be acquired by a camera system and work as a tool for a machine learning algorithm. This feature allows personnel to assess changes underwater before and after the extraction process.

Significant to note is that artificial intelligence in the present invention learns from its prior experience in weed collection. There is a cloud computing/data storage dimension as well, so there is an option to centrally monitor what is being harvested in each ecosystem and how the semi-autonomous vehicle identifies and removes invasive species.

In one embodiment, a feedback response is generated from the technology of the cleaning apparatus. One may also be able to gather regional, large scale data collection regarding the conditions of bodies of water through feedback loop testing and sensing, providing valuable insights to a myriad of industries and the scientific community as a whole. This feature of origination enables broader control and analysis of freshwater assets and democratizes the data that is elucidated therein. In another embodiment, these teleoperated robotic lake or aquatic cleaning apparatus can provide data about the conditions of the aquatic environment it occupies, thus democratizing information regarding the health of aquatic bodies. Some of the information it can determine are the dissolved oxygen levels, dissolved phosphorous, alkalinity, turbidity, temperature, and other contamination concerns, data on the health of aquatic bodies and other pre-emptive information—all elements of the monitorization system's broad capability.

In yet another embodiment of the present invention, semi-autonomous robotic lake or aquatic cleaning apparatus have peer to peer communication capabilities. This allows them to communicate with one another and a host, who can monitor and surveil the robot for any signs of wear or disruptions on its course. These smart underwater aquatic cleaners can procure self-diagnostics (status reports) and relay updates such as their precise geographical location, travel history, where the most growth occurs or where significant amounts of AIS have been collected, and after persistent scouring, they may be able to provide insights such as factors that may contribute to growth in specific regions and locales.

For the milfoil or invasive species collection process, the initial iteration of the robotic apparatus utilizes a thick metal (or similar rigid material) rake-like attachment that also uses suction to gather AIS. It is contemplated that future iterations might also use compressed air, or a high-pressure stream of water to dislodge the root systems of the plants or other mechanical motion/apparatus to interact with the lake bottom to extract the root system and entire stalk and fragments of the plant. A combination of all of those apparatuses is also envisioned. Collected aquatic invasive species are then filtered through a tube or funnel that may be connected to the body of the semi-autonomous lake or aquatic cleaning apparatus. The robotic lake or aquatic cleaning apparatus then uses light sensors/cameras/sonar or other sensing equipment to effectively identify and capture stray fragments and other species and filter them from the water. The aquatic invasive species are collected at the source, with the goal of minimizing growth, thus slowing the rate of reproduction and invasiveness.

Sound propagation and triangulation is a unique technique used to determine the location of objects of interest or, in the present invention's case, plant species of interest. Acoustic positioning uses soundwave propagation to measure distances between objects of interest and acoustic transponders and sensors. In an embodiment present invention, transponders are responsible for releasing signals in response to a query from personnel monitoring the extraction process, however, they may be autonomous in particular adaptations.

Another facet of the present invention are the light sensors that help guide the apparatus through invasive species and milfoil. It also provides additional lighting for personnel, who may view the process aboard a vessel, or from a monitoring station. While the lake or aquatic cleaning apparatus features sensors that assist with avoiding obstructions, the option to manually view objects is still available. This may be beneficial for personnel, scientists or individuals who want to analyze the contents of a body of water or provide updates regarding the volume and type of debris collected. Manual control can be augmented by autonomous features, and in environments or conditions where the autonomous features are not available, human intervention can control the vehicles and continue to collect AIS.

The collected weeds will then be dumped into a completely autonomous dump barge that can assess when it is full and may traverse around aquatic bodies to collect more invasive species without human guidance or control. In essence, the dump barge is autonomously operated and utilizes artificial intelligence and machine learning as well as GPS positioning and range finding components to execute tasks, thereby minimizing the need for excessive human labor power.

The aquatic cleaning apparatus may be above a body of water or beneath a body of water depending on a myriad of factors, such as local and state laws regarding the proximity of an autonomous underwater vehicle to the bottom of a body of water.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is a depiction of the present invention's sonar/camera/sensor capabilities in communication with an external device or receiving electronic.

FIG. 2 is a diagram that depicts the present invention's capacities relative to other approaches, such as DASH (Diver Assisted Suction and Harvesting).

FIG. 3 is an exemplary model of the recorded view, data transmission and statistics of the present invention.

FIG. 4 is a depiction of the remotely operated vehicle (ROV) or lake or aquatic cleaning apparatus.

FIG. 5 is a depiction of the dump barge and siphoning mechanism, wherein waste is filtered, stored and transported to the collection site, as well as water filtration before water is returned to the lake.

FIG. 6 is a depiction of the present invention's command vehicle integration.

FIG. 7 is a schematic of the present invention's use of artificial intelligence.

FIG. 8 is a schematic of the present invention's use of an Artificial Intelligence machine learning platform to create proprietary control/navigation/orientation and positioning software to improve extraction efficiency.

FIG. 9 is a diagram depicting the platform's web service infrastructure.

FIG. 10 is a depiction of the platform's web services, as well as the components of an exemplary operating environment in which embodiments of the present invention may be implemented.

FIG. 11 is an illustration of a multi-server room and the various locations in which other pertinent server rooms may exist.

FIG. 12 is a diagram disclosing the relationship between the cloud server, a computing device with a central processing unit operated by a client, the internet, and a server.

FIG. 13 is a diagram of the flow of access between the platform of the present invention and the web services client via cloud software tools.

FIG. 14 is a diagram of an example of the cloud storage organization in which the web services accesses and retrieves user data as objects in buckets within a cloud storage space.

### DETAILED DESCRIPTION OF THE PREFERRED EMBODIMENT

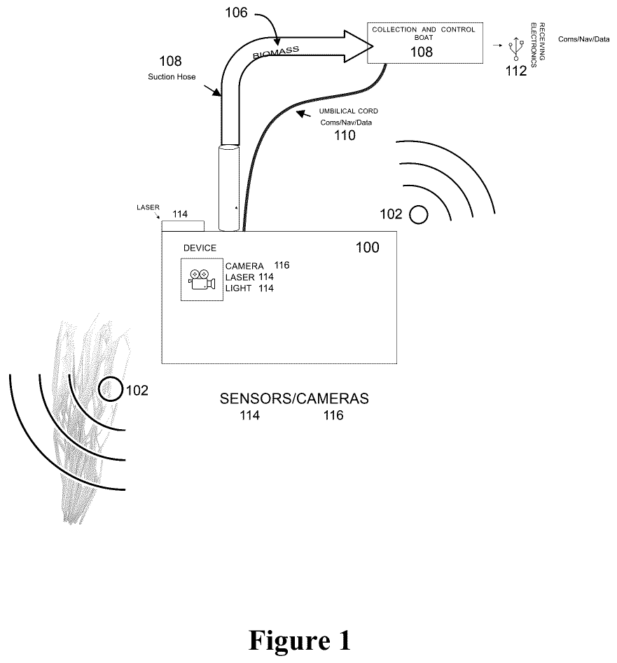

FIG. 1 depicts the present invention's use of sonar technology 102 which typically aids in navigation and range. Sound propagation and sonar technology 102 assists greatly in an aquatic environment and is used to help navigate distance and detect objects that may be on or under the water. Sonar technology 102 may be used by the present invention 100 to detect target species 104, avoid obstacles, and for navigation and orientation. The primary function of the present invention is to extract aquatic invasive species (or target species) 104, such as water milfoil, and remove all of the biomass 106, which may include both plant and/or animal organisms, and fragments, leaving no viable biomass 106 behind. The present invention communicates remotely to a collection and control hub 108, transmitting communication and navigation data 110 to receiving electronics 112 and in displaying data regarding the extraction process as well as other data that may be essential for remote personnel. The present invention may use additional sensors 114, such as light sensors and laser sensors, and cameras 116. The present invention 100 extracts target species 104 by way of a suction hose 118 to collect and remove all biomass 106.

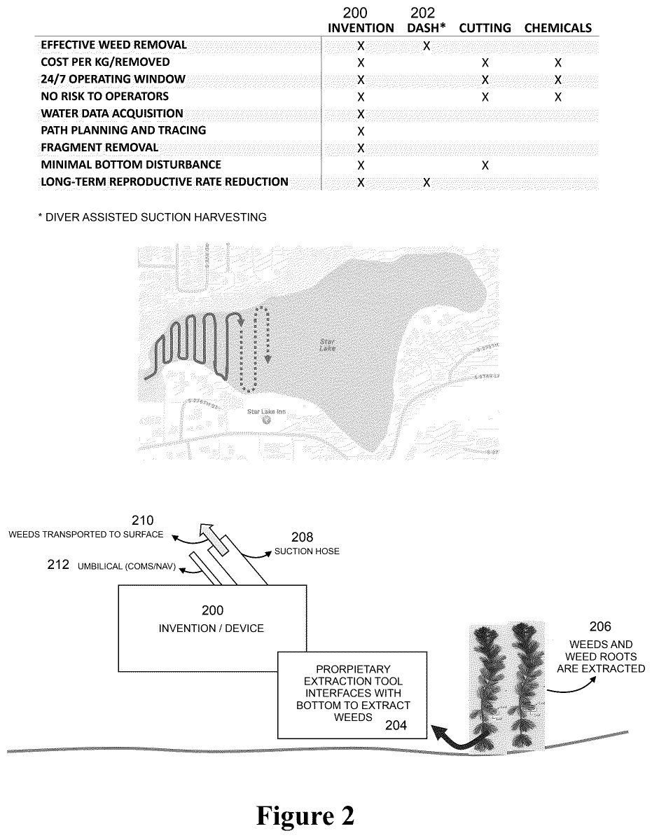

FIG. 2 depicts a comparison between diver assisted suction harvesting (DASH) 202 of aquatic invasive species (AIS) versus the present invention's teleoperated robotic lake or aquatic cleaning system 200 which features sensing technology and AI, as well as machine learning. The cleaning apparatus 200 is capable of harvesting over three times the number of debris in comparison to diver assisted suction harvesters 202. The present invention 200 uses a proprietary extraction tool 204 to interface with the bottom of a body of water to extract biomass 206 such as weeds and weed roots. The biomass is collected through a suction hose 208 and transported to the surface 210 for further removal, such as an autonomous dump barge. The remotely operated vehicle contains suction technology that allows aquatic invasive species (AIS) to be pulled by the root and into the debris cleaner. The biomass debris is then collected via fluid or mechanical means that siphon it through either a filter, funnel, or suction device. The present invention 200 may incorporate path planning and tracing to cover targeted areas in the body of water, both in two-dimensional tracing on the surface as well as depth. Data capture will enable three-dimensional weed removal capability as well as data capture for analysis and inspection purposes. This captured data can be transmitted by way of an umbilical tether 212.

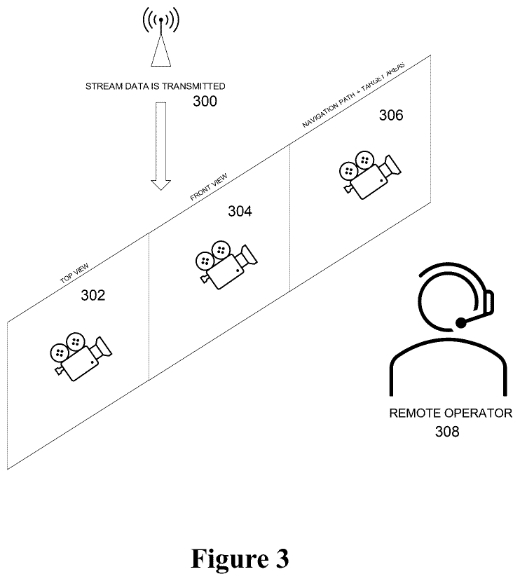

FIG. 3 is an exemplary model of the recorded view, data transmission and statistics of the present invention. In accordance with the preferred embodiment, stream data 300, such as a top view 302, front view 304, navigation path and target area 306 recorded feeds are transmitted to a remote operator 300. The remote operator 300 personnel analyze the live or recorded footage 300 from the autonomous lake or aquatic cleaning apparatus. The footage from the camera feed enables inspection of the body of water. Personnel 308 may be on a vessel nearby or on the body of water it is monitoring, as the remotely operated vehicle and lake or aquatic cleaning apparatus may feature cameras that enable control and access to footage regardless of proximity.

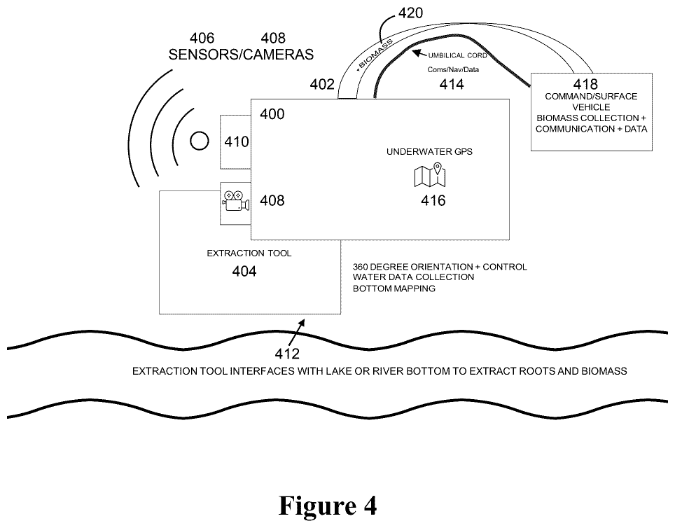

FIG. 4 is a depiction of the robotic lake or aquatic cleaning apparatus 400 or remotely operated vehicle (ROV) 400. The lake or aquatic cleaning apparatus 400 features a siphon, filter, or funnel 402 that is connected to the device 400. Within the lake or aquatic cleaning apparatus 400 may be mechanical extraction mechanisms 404 (like gears, or rotary catchment systems), proprietary suction funnels or custom streams of water that allow the remotely operated vehicle 400 to collect/digest aquatic invasive species and capture all of the targeted biomass 420, which may include both plant and/or animal organisms, roots, stalk, leaflets (whorls), and fragments (AIS), so that the biomass in its entirety may move through the siphon, filter, or funnel 402 with ease. The apparatus 400 also have additional features, by way of example and not by way of limitation, such as suction power to assist with the collection of aquatic invasive species alongside sensors 406, cameras 408, and sonar technology 410 that illuminate, monitor, or surveil the vehicle's path along the bottom of the body of water 412, ensuring that individuals such as personnel can properly assess its mechanisms. The extraction tool 404 interfaces with the bottom of the body of water 412 to extract roots and biomass 420. The ROV 400 uses an umbilical tether 414 to transmit communication and navigation data and underwater global positioning system (GPS) data 416 to the surface vehicle 418. The ROV 400 may use the combination of sonar technology 410, sensors 406 and cameras 408 with underwater GPS 416 to allow for 360-degree orientation and control, as well as water data collection and mapping of the bottom of the body of water 412.

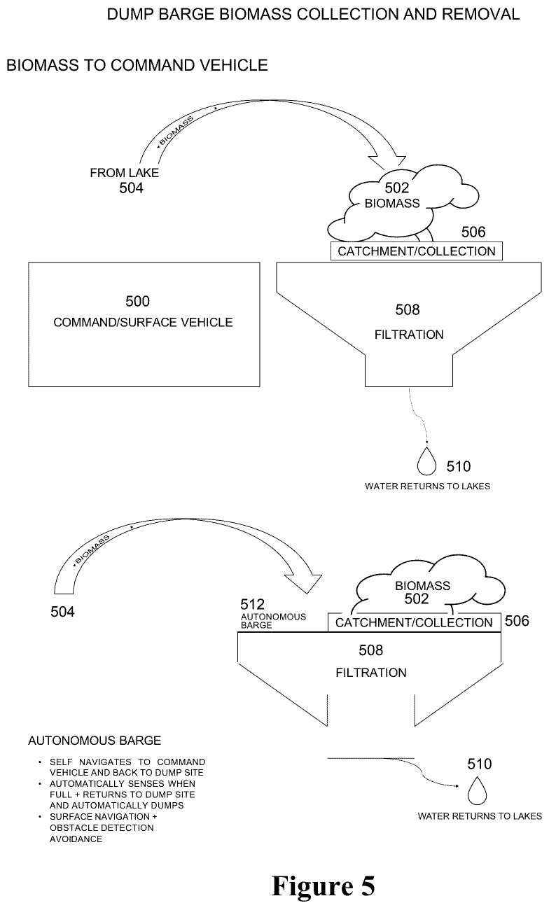

FIG. 5 is a depiction of the siphoning mechanism in the present invention. In accordance with the preferred embodiment of the present invention, the command or surface vehicle 500 collects the biomass 502 from the bottom of the body of water 504 into catchment and collection 506. This collected biomass undergoes filtration 508 and the filtered water 510 is returned to the body of water, free from biomass. An autonomous barge 512 may self-navigate to the command vehicle 500 and back to the dump site, automatically sensing when full, and using surface navigation and obstacle detection and avoidance mechanisms. The siphoning device which may be a series of tubage, filters, or funnels which hover or are positioned over a vessel or vehicle and release aquatic invasive species biomass and excess water into a barge. Screening may be used to filter aquatic invasive species (AIS) biomass from excess water. In essence, the siphoning mechanisms allow for the removal of target aquatic invasive species biomass and or organisms or items of interest from bodies of water through suction and pressure, and then filter excess to ensure that biomass, organisms, items, or articles of interest do not reenter the ecosystem.

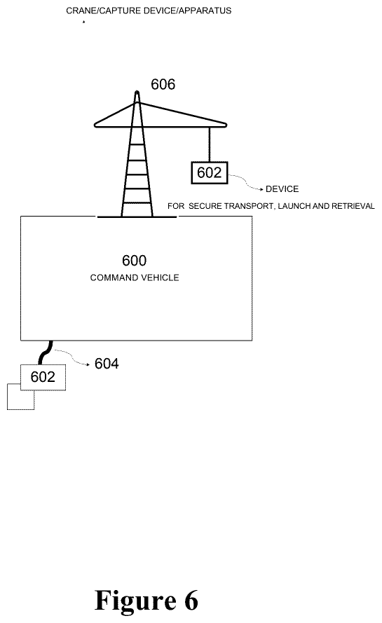

FIG. 6 is a depiction of the present invention's command vehicle integration. In accordance with the preferred embodiment, the command vehicle 600 can capture, release, store and transport the apparatus 602. The apparatus 602 is tethered 604 to the command vehicle 600. The command vehicle 600 interacts with a crane mechanism 606, used to capture, transport launch and retrieve the apparatus 602 during various stages of use. The robotic aquatic cleaning apparatus 602 can be docked on a claw or arm on a crane 606 that is attached to the command vehicle 600. The semi-autonomous aquatic cleaning apparatus 602 may be stored aboard a command vehicle 600, or conjoined onto various vessels, vehicles, or crafts. The command vehicle 600, such as a boat, features personnel preparing to operate, monitor and view the aquatic debris cleaning apparatus 602 procurement process. The cleaning apparatus 602 features gears/clamps or other mechanical manipulation that may further crush or condense aquatic invasive species (AIS) so that it can be properly siphoned through the filter, funnel or siphoning device. For the cleaning apparatus 602 to be deployed, the command vehicle 600 may feature a claw, arm, or crane capture device 606 which houses it. Once deployed, personnel may be able to view and control the settings and pathways of the cleaning apparatus 602 as well as other system configurations, on the command vehicle 600.

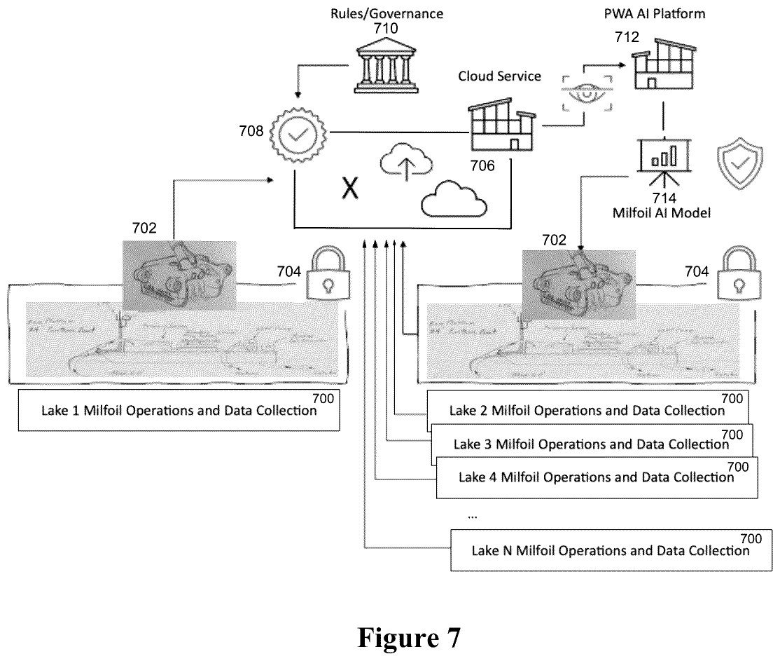

FIG. 7 is a schematic of the present invention's artificial intelligence (AI) platform capabilities and infrastructure. Operational data 700 is collected by the aquatic cleaning apparatus 702 and is securely stored 704 and transmitted to a cloud server database 706. The input consists of multiple sources or storage nodes which feature an array of contexts from different sources. The data 700 is authenticated or verified 708 using sources to assist with the system's configuration of patterns and rules 710, such as desired models and algorithms that help generate the desired output. The data is integrated into the present inventions AI platform 712 and used to generate an AI model of the aggregated data 714. The desired output is generated by way of knowledge correspondence or knowledge matching and mapping, and this may be replicated to further assist with the embodiment's machine learning.

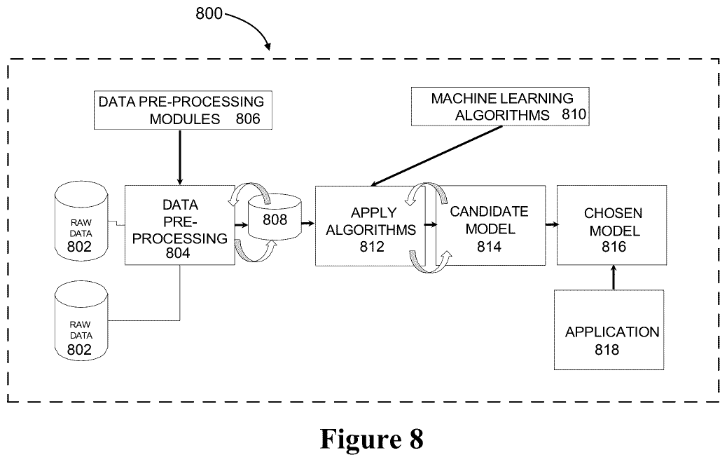

FIG. 8 is another schematic of the AI platform and model 800 for machine learning. In accordance with the preferred embodiment, the present invention utilizes an AI machine learning platform 800 in order to collect raw metadata 802 on aquatic invasive species and objects of interests in order to control the semi-autonomous robotic and aquatic or lake cleaning apparatus. For example, raw metadata 802 may be collected to assess the characteristics of an aquatic invasive species (AIS) or objects of interest. Raw data 802 is pre-processed 804 using data pre-processing modules 806. The data is prepared 808 for the application 812 of AI machine learning algorithms 810. Once the AI algorithms 810 have been applied 812 to the data, candidate models 814 are formed. A chosen model 816 is selected by the application 818 from the candidate models. This is achieved through hidden layers, which are software layers that can analyze and differentiate data in order to reach a conclusion. The conclusion may regard a particular object, article, or plant as invasive or non-invasive and determine whether it should be siphoned or collected.

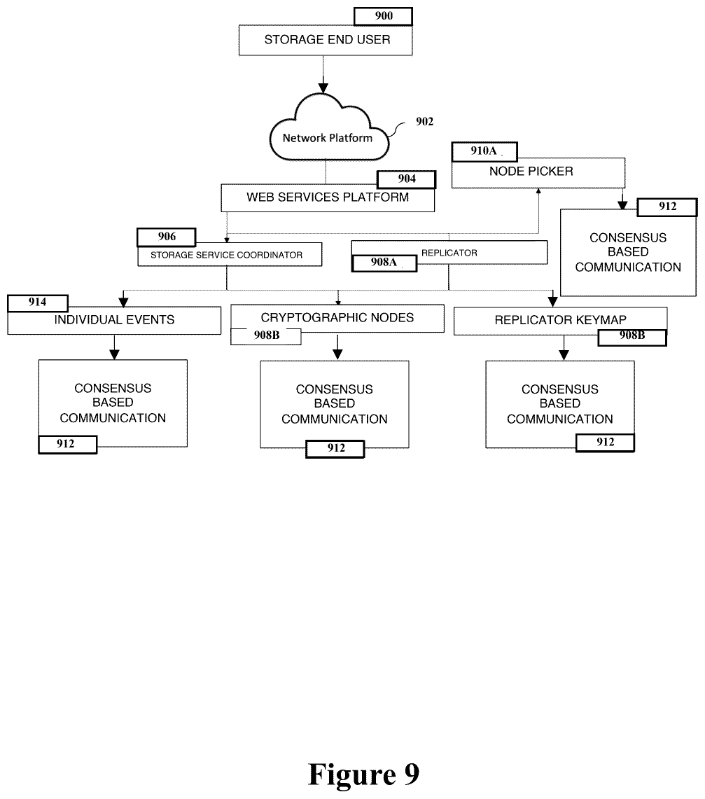

FIG. 9 is a diagram showing the communication between the storage end users 900, the network platform 902 and the various elements that help effectuate operations. The storage end user communicates and relays various pertinent bits of data to the web services platform 904. The network platform 902 operates on the web service platform 904, which features a storage service coordinator 906 and replicator 908A. Each of these services utilize a node picker 910A which helps establish consensus-based communication 912. The storage service coordinator 906 maintains and records individual events 914 and cryptographic nodes 908B, or keys that are used for operations. The replicator has its own keymap 908B which generates consensus-based communication 912, alongside the cryptographic nodes and individual events.

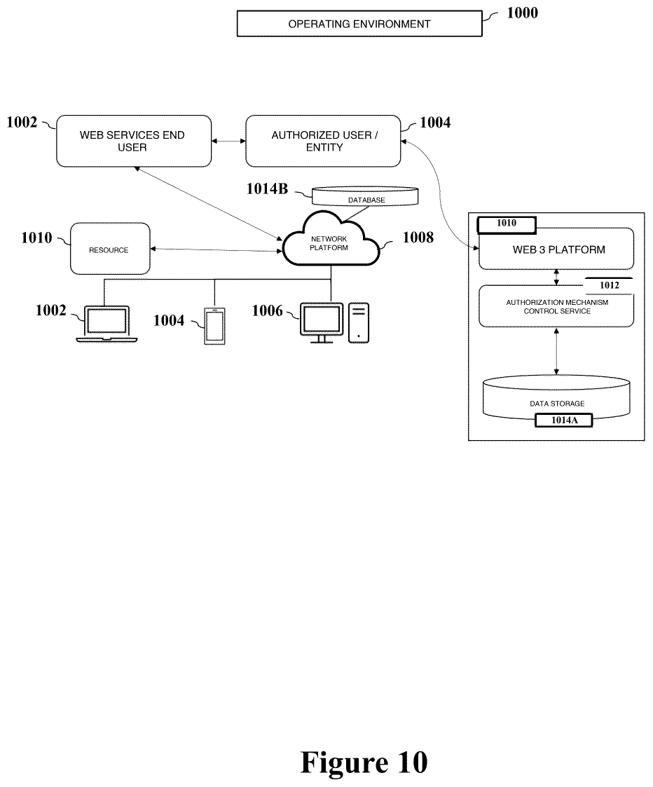

FIG. 10 is a diagram showing the web services of the platform and system. The platform and system are all components of an exemplary operating environment 1000 in which embodiments of the present invention may be implemented. The system can include one or more user computers 1002, computing devices 1004, or processing devices 1006 which can be used to operate a client, such as a dedicated application, web browser, etc. The user computers can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers may also have any of a variety of applications, including one or more development systems, database client and/or server applications, and Web browser applications. Alternatively, the user computers may be any other electronic device, such as a thin-client computer, Internet-enabled gaming system, and/or personal messaging device, capable of communicating via a network (e.g., the network described below) and/or displaying and navigating Web pages or other types of electronic documents. Although the exemplary system is shown with four user computers, any number of user computers may be supported.

In most embodiments, the system includes some type of network 1008. The network can be any type of network familiar to those skilled in the art that can support data communications using any of a variety of commercially-available protocols, including without limitation TCP/IP, SNA, IPX, AppleTalk, and the like. Merely by way of example, the network can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, WiMAX, WiFi, CDMA 2000, WCDMA, the Bluetooth protocol known in the art, and/or any other wireless protocol); and/or any combination of these and/or other networks.

The system may also include one or more server computers which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers may be dedicated to running applications, such as a business application, a Web server, application server, etc. Such servers may be used to process requests from user computers. The applications can also include any number of applications for controlling access to resources 1010 of the servers.

The web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers. As one example, a server may execute one or more Web applications. The Web application may be implemented as one or more scripts or programs written in any programming language, such as Java.RTM., C, C #, or C++, and/or any scripting language, such as Perl, Python, or TCL, as well as combinations of any programming/scripting languages. The server(s) may also include database servers, including without limitation those commercially available from Oracle.RTM., Microsoft.RTM., Sybase.RTM., IBM.RTM. and the like, which can process requests from database clients running on a user computer.

End users 1002, or users that are viewing and using the network platform, all contribute data to the cloud. A web service platform 1010 helps secure that data and maintain the service's functionalities. Only authorized users 1004 and entities can authorize or unauthorize content and monitor data stored within the web service 1012. The platform's web services help maintain the operations of elements managed by the storage system 1014A.

The system may also include one or more databases 1014B. The database(s) may reside in a variety of locations. By way of example, a database may reside on a storage medium local to (and/or resident in) one or more of the computers. Alternatively, it may be remote from any or all of the computers, and/or in communication (e.g., via the network) with one or more of these. In a particular set of embodiments, the database may reside in a storage-area network (“SAN”) familiar to those skilled in the art. Similarly, any necessary files for performing the functions attributed to the computers may be stored locally on the respective computer and/or remotely, as appropriate. In one set of embodiments, the database may be a relational database, such as Oracle 10 g, that is adapted to store, update, and retrieve data in response to SQL-formatted commands.

The infrastructure of the present invention also allows for the use of web services that enable interaction with and storage of data across devices. Specifically, these web services can allow for the use of cloud software tools and cloud-based data storage. Cloud software tools can be used to allow for increased user authentication and authorization checkpoints for data accessed between parties. The web service software aids in the transmission of data between entities while still maintaining secure access restrictions preventing any unauthorized access to the cloud data.

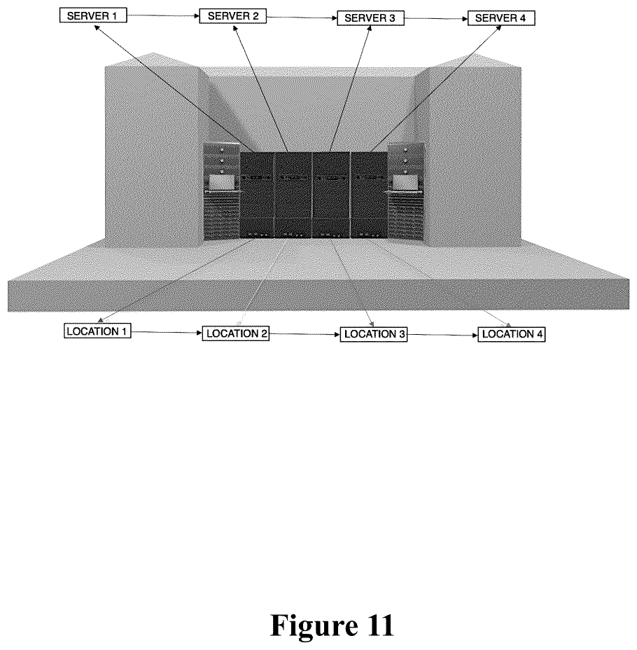

FIG. 11 is an illustration of server-to-server connections, within a server room and to other sever room locations. The web server undergoes an initialization process and features a database of wireless network data. Dependent on the service requested, the data may undergo processing. The servers actively attempt to retrieve the appropriate data to provide user input. Data may then be formatted, and with the appropriate authorizations, saved or restructured.

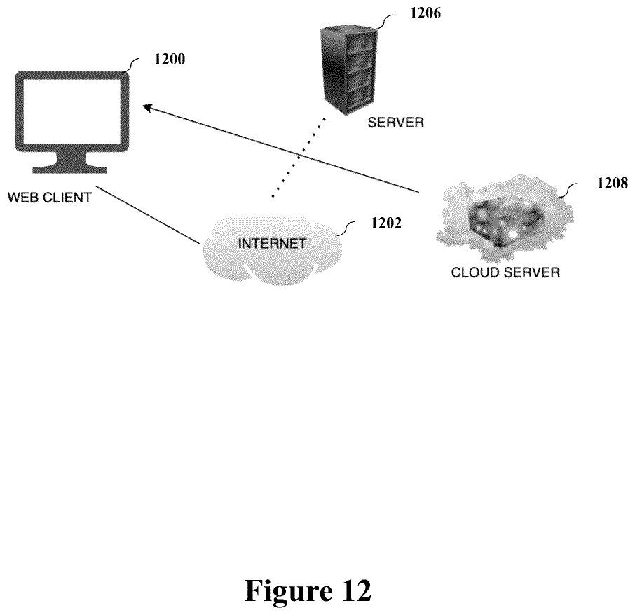

FIG. 12 is a diagram disclosing the relationship between the cloud server 1208, a computing device with a central processing unit operated by a client 1200, the internet 1202, and a server 1206. In accordance with the preferred embodiment, a web client 1200 interacts with the server ecosystem by way of a service connection, such as the internet 1202, which then distributes data and pertinent information such as the web service platform to the cloud server 1208 and preliminary servers. This allows for data to be streamlined between the client and the server as well as cloud servers and other database systems. Communication between web services may be completed via Simple Object Access Protocol (SOAP) which allows multiple web service applications to communicate rapidly and efficiently and to provide data to the web client.

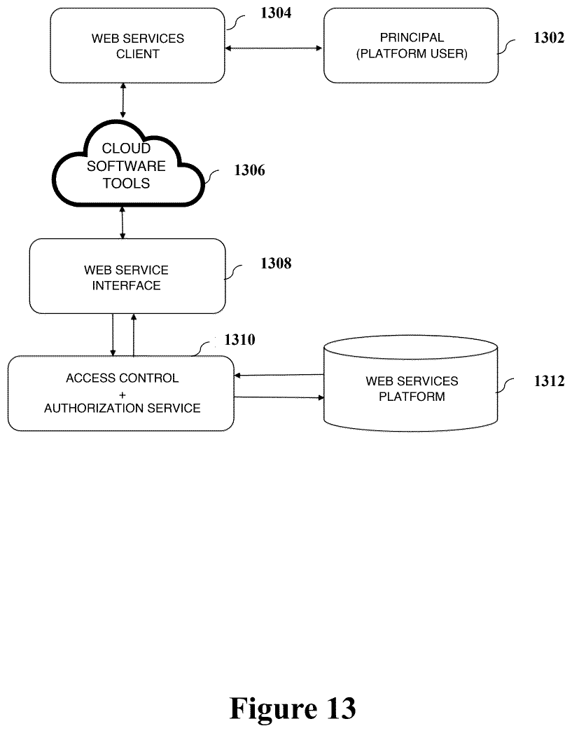

FIG. 13 is a diagram of the flow of access between the platform of the present invention and the web services client via cloud software tools. The principal or platform user 1302 accesses the web services client 1304, which then transmits data via cloud software tools 1306 to the web services interface 1308. Access control and authorization 1310 acts as a layer in order to access the web services platform 1312 by way of the web services interface.

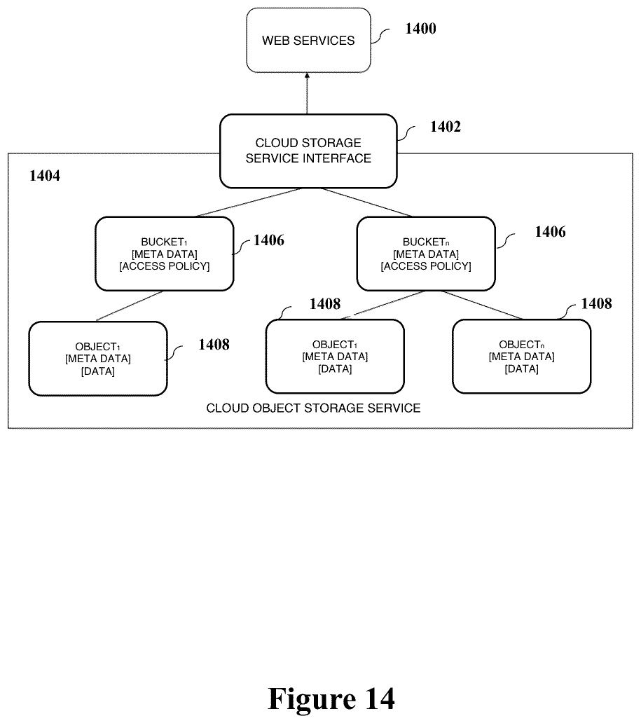

FIG. 14 is a diagram of an example of the cloud storage organization in which the web services 1400 accesses and retrieves user data as objects in buckets within a cloud storage space 1404. The cloud storage service 1406 is a means of storing and protecting any amount of data for a range of use cases. A bucket 1406 is a container for objects stored in the cloud storage service, and objects 1408 consist of object data and metadata. The metadata is a set of name-value pairs that describe the object. These pairs include some default metadata, such as the date last modified, and standard HTTP metadata, such as Content-Type. You can also specify custom metadata at the time that the object is stored. Web services provide access to and from the cloud object storage service 1406 via the cloud storage service interface 1402.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A water cleaning vehicle for deployment within a body of water comprising:
a mobility mechanism for enabling said vehicle to move within said body of water;
a sensor for determining biomasses; and
a removal mechanism for removing any of said biomasses from within said body of water under control by an operator of said water cleaning vehicle.

2. A water cleaning vehicle according to claim 1 wherein said biomasses contain animal organisms.

3. A water cleaning vehicle according to claim 1 wherein said biomasses contain plant organisms.

4. A water cleaning vehicle according to claim 1 wherein artificial intelligence is deployed to enable said water cleaning vehicle to efficiently move to maximize any number of biomasses to be removed from said body of water.

5. A water cleaning vehicle according to claim 1 wherein said artificial intelligence is programmed to remove targeted biomasses from within said body of water.

6. A water cleaning vehicle according to claim 1 operated by way of radio frequency communications establishing a communications link between said water cleaning vehicle and said operator of said water cleaning vehicle.

7. A water cleaning vehicle according to claim 1 operated by way of a communications tether establishing a communications link between said water cleaning vehicle and said operator of said water cleaning vehicle.

8. A water cleaning vehicle according to claim 7 wherein a hose is used for enabling removal of biomasses from said body of water.

9. A method for cleaning a body of water comprising:
deploying a mobile mechanism to move within said body of water;
activating a sensor for determining biomasses contained within said body of water; and
controlling a removal mechanism for removing any of said biomasses from within said body of water under control by an operator of said water cleaning vehicle.

10. A method for cleaning a body of water according to claim 9 wherein said biomasses contain animal organisms.

11. A method for cleaning a body of water according to claim 9 wherein said biomasses contain plant organisms.

12. A method according to claim 9 wherein artificial intelligence is deployed to enable said water cleaning vehicle to efficiently move to maximize any number of biomasses to be removed from said body of water.

13. A method according to claim 9 wherein said artificial intelligence is programmed to remove targeted biomasses from within said body of water.

14. A method according to claim 9 wherein said water cleaning vehicle is operated by way of radio frequency communications establishing a communications link between said water cleaning vehicle and said operator of said water cleaning vehicle.

15. A method according to claim 9 wherein said water cleaning vehicle is operated by way of a communications tether establishing a communications link between said water cleaning vehicle and said operator of said water cleaning vehicle.

16. A method according to claim 15 wherein said water cleaning vehicle includes a hose for enabling removal of biomasses from said body of water connected to said water cleaning vehicle.

17. A water cleaning system for deployment within a body of water comprising:
a mobility mechanism for enabling said vehicle to move within said body of water;
a sensor for determining biomasses;
a removal mechanism for removing said any of said biomasses from within said body of water under control by an operator of said water cleaning vehicle; and
a diver assisted suction harvesting is utilized to remove any of said biomasses from said body of water;
wherein artificial intelligence is deployed to enable said water cleaning vehicle to efficiently move to maximize any number of biomasses to be removed from said body of water.

18. A water cleaning system according to claim 17 wherein said artificial intelligence is programmed to remove targeted biomasses from within said body of water.

19. A water cleaning system according to claim 17 operated by way of radio frequency communications establishing a communications link between said water cleaning vehicle and said operator of said water cleaning vehicle.

20. A water cleaning system according to claim 17 operated by way of a communications tether establishing a communications link between said water cleaning vehicle and said operator of said water cleaning vehicle, and wherein said water cleaning system includes said tether with a hose for enabling removal of biomasses from said body of water and wherein said system includes a live camera feed to enable inspection of said body of water.
